(19) United States
(12) Patent Application Publication
(10) Pub. No.: US 2025/0232453 A1
(43) Pub. Date: Jul. 17, 2025

(54) INFORMATION PROCESSING DEVICE, COMPUTER PROGRAM PRODUCT, AND INFORMATION PROCESSING METHOD

(71) Applicant: KABUSHIKI KAISHA TOSHIBA, Tokyo (JP)

(72) Inventors: Nao MISHIMA, Inagi (JP); Satoshi ITO, Kawasaki (JP); Tomoyuki SHIBATA, Kawasaki (JP); Reiko NODA, Kawasaki (JP)

(73) Assignee: KABUSHIKI KAISHA TOSHIBA, Tokyo (JP)

(21) Appl. No.: 19/014,950

(22) Filed: Jan. 9, 2025

(30) Foreign Application Priority Data
Jan. 17, 2024 (JP) 2024-004947

(51) Int. Cl. G06T 7/246; G06V 10/44; G06V 10/80

(52) U.S. Cl. CPC G06T 7/246; G06V 10/44; G06V 10/817; G06T 2207/30201; G06V 2201/07

(57) ABSTRACT

An information processing device includes one or more hardware processors configured to function as a detection unit, a collation unit, a voting unit, and a determination unit. The detection unit detects a tracking target region including a tracking target from a video frame. The collation unit collates the tracking target using a collation dictionary that stores identification information for identifying a collation target and acquires identification information for identifying a collation result in the frame of the tracking target from the collation dictionary. The voting unit obtains voting data by voting, for each of tracking targets, the identification information for identifying the collation result obtained for each of frames. The determination unit determines whether to settle collation based on the voting data and outputs identification information for identifying the settled collation result when the collation is settled.

### CROSS-REFERENCE TO RELATED APPLICATIONS

This application is based upon and claims the benefit of priority from Japanese Patent Application No. 2024-004947, filed on Jan. 17, 2024; the entire contents of which are incorporated herein by reference.

### FIELD

Embodiments described herein relate generally to an information processing device, a computer program product, and an information processing method.

### BACKGROUND

As a method of heightening accuracy of collation of a person in a video, best shot selection is known in the related arts. For collation of a person, when the person is entirely and clearly captured, collation accuracy is improved compared to the face or body being cut-off in the captured image. On the other hand, even when the entirety of a person is captured, if the person is excessively positioned distantly and thus looks too small, the collation accuracy decreases. For collation, it is desirable to frame a person at an appropriate angle of view. Best shot selection is a method of defining conditions of an appropriate angle of view in advance and using an image that satisfies the conditions as a best shot for collation.

However, in the related arts, it is difficult to shorten a processing time required for settling collation of a target without a decrease in collation accuracy.

### BRIEF DESCRIPTION OF THE DRAWINGS

FIG. 1 is a diagram illustrating a summary of information processing according to a first embodiment;

FIG. 2 is a diagram illustrating an example of a functional configuration of an information processing device according to the first embodiment;

FIG. 3 is a diagram illustrating an example of a collation process of an object according to the first embodiment;

FIG. 4 is a flowchart illustrating an example of an overall flow of the information processing according to the first embodiment;

FIG. 5 is a flowchart illustrating an example of a detection and tracking process of an object according to the first embodiment;

FIG. 6 is a flowchart illustrating an example of a voting process according to the first embodiment;

FIG. 7 is a flowchart illustrating an example of a determination process according to the first embodiment;

FIG. 8 is a diagram illustrating a relationship between the number of votes and collation accuracy in the first embodiment;

FIG. 9 is a diagram illustrating an example of a functional configuration of an information processing device according to a first modification example of the first embodiment;

FIG. 10 is a diagram illustrating an example of a functional configuration of an information processing device according to a second modification example of the first embodiment;

FIG. 11 is a diagram illustrating an example of a functional configuration of an information processing device according to a third modification example of the first embodiment;

FIG. 12 is a diagram illustrating an example of a functional configuration of an information processing device according to a second embodiment;

FIG. 13 is a diagram illustrating an example of a functional configuration of an information processing device according to a third embodiment; and

FIG. 14 is a diagram illustrating an example of a hardware configuration of the information processing devices according to the first to third embodiments.

### DETAILED DESCRIPTION

An information processing device according to an embodiment includes one or more hardware processors configured to function as a detection unit, a collation unit, a voting unit, and a determination unit. The detection unit is configured to detect a tracking target region including a tracking target from a frame in a video. The collation unit is configured to collate the tracking target using a collation dictionary that stores identification information for identifying a collation target and to acquire identification information for identifying a collation result in the frame of the tracking target from the collation dictionary. The voting unit is configured to obtain voting data by voting, for each of tracking targets, the identification information for identifying the collation result obtained for each of frames. The determination unit is configured to determine whether to settle collation based on the voting data and to output identification information for identifying the settled collation result when the collation is settled.

Hereinafter, exemplary embodiments of an information processing device, a computer program product, and an information processing method will be explained below in detail with reference to the accompanying drawings.

### First Embodiment

In a first embodiment, a case where an object ID for identifying an object is collated with the object in an image acquired by a camera or a video camera will be described.

### Summary of Information Processing

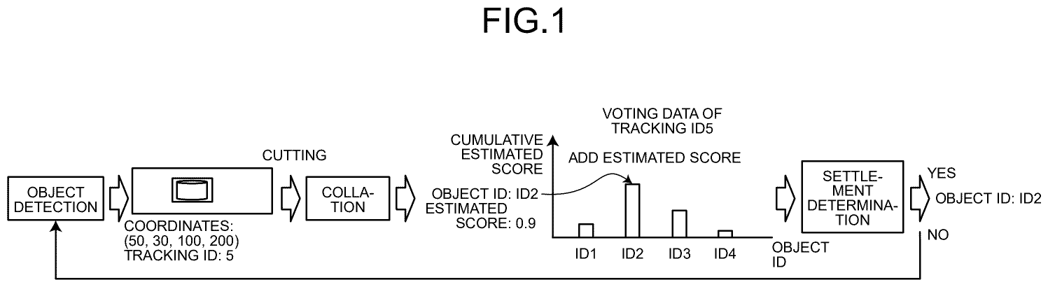

FIG. 1 is a diagram illustrating a summary of information processing according to the first embodiment. By introducing a voting mechanism, an information processing device according to the first embodiment simultaneously achieves improvement of collation accuracy and a reduction in time until collation settlement.

As illustrated in FIG. 1, in the information processing according to the first embodiment, first, an object is detected from an image of one frame in a video.

Next, a target region including the detected object is cut. The target region is represented by coordinate information representing two vertexes that specify a rectangular region (for example, a set of a vertex of a lower left side of a rectangle and a vertex of an upper right side of the rectangle). The detected object is identified by a tracking ID.

Next, the object identified by the tracking ID is collated (estimated), and an object ID and an estimated score representing certainty of estimation of the object ID are obtained. For example, the estimated score is represented by a numerical value of 0 or more and 1 or less, and is indicative of the higher certainty of the estimation as the numerical value is larger.

Next, the object ID and the estimated score obtained by the collation in the frame are voted for each of the tracking IDs. For example, the voting is performed by adding the estimated score. As illustrated in FIG. 1, voting data is represented by a histogram of identification information (in the example of FIG. 1, the object ID) for identifying a collation result.

Next, when the determination for the collation settlement is performed and collation is not settled, the above-described information processing is performed on an image of the next one frame. When the collation is settled, an object ID having the highest cumulative estimated score is output.

Next, an example of a functional configuration of the information processing device according to the first embodiment will be described.

### Example of Functional Configuration

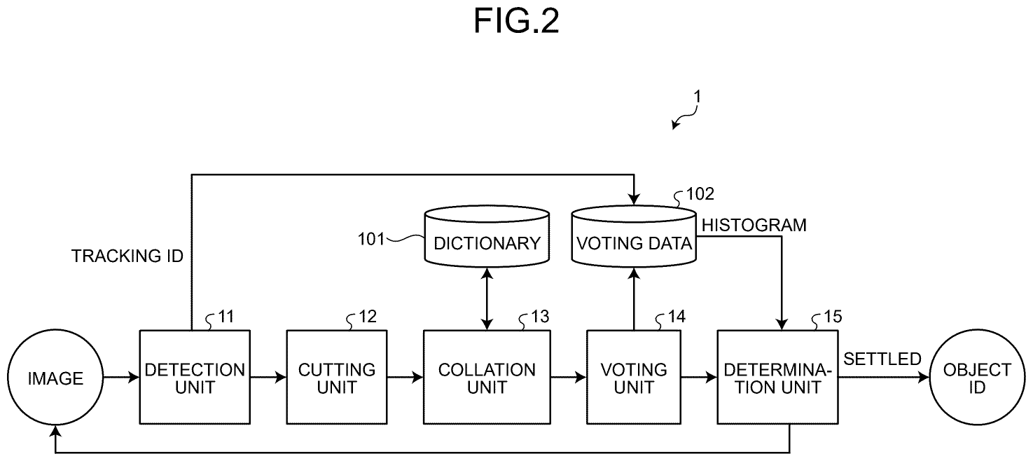

FIG. 2 is a diagram illustrating an example of a functional configuration of an information processing device 1 according to the first embodiment. The information processing device 1 according to the first embodiment includes a detection unit 11, a cutting unit 12, a collation unit 13, a voting unit 14, and a determination unit 15. The information processing device 1 according to the first embodiment stores a dictionary 101 and voting data 102.

The detection unit 11 detects a tracking target region including a tracking target (in the first embodiment, an object) from a frame in a video. The cutting unit 12 cuts the tracking target region from the frame.

The collation unit 13 collates the tracking target using a collation dictionary (in the first embodiment, the dictionary 101) that stores identification information for identifying a collation target (in the first embodiment, the object ID) and acquires identification information for identifying a collation result in the frame of the tracking target from the dictionary 101. Specifically, the collation unit 13 acquires the identification information for identifying the collation result in the frame of the tracking target from the dictionary 101 by extracting a feature amount of the tracking target in the tracking target region and collating the tracking target based on a similarity between the feature amount of the tracking target and the feature amount stored in the dictionary 101.

The voting unit 14 obtains the voting data 102 by voting, for each of the tracking targets, the identification information for identifying the collation result obtained for each of the frames.

Specifically, when the voting data 102 is represented by a histogram, when the identification information for identifying the collation result obtained for each of the frames is voted for each of the tracking targets, the voting unit 14 forms a histogram by adding the estimated score representing the certainty of the collation result. In addition, for example, when the identification information for identifying the collation result obtained for each of the frames is voted for each of the tracking targets, the voting unit 14 forms a histogram by adding a predetermined value (for example, 1).

The determination unit 15 determines whether to settle collation based on the voting data 102 and outputs identification information for identifying the settled collation result (in the first embodiment, the object ID) when the collation is settled.

Specifically, when the voting data 102 is represented by a histogram, the determination unit 15 determines whether to settle collation based on at least one of a frequency of the histogram for each piece of the identification information for identifying the collation result and a voting probability for each piece of the identification information for identifying the collation result. The determination unit 15 may change at least one of a threshold used for determining the frequency of the histogram (for example, the cumulative estimated score) and a threshold used for determining the voting probability depending on a type of the collation target. For example, the threshold used for determining the frequency of the histogram (for example, the cumulative estimated score) may be set to be lower as collation of the object is more difficult.

The dictionary 101 stores an object ID and a feature vector (an example of the feature amount) representing a feature of an object identified by the object ID.

The voting data 102 is stored for each of the tracking IDs. The voting data 102 for each of the tracking IDs stores the cumulative estimated score for each of the object IDs (voting destination labels) for identifying an object estimated for each of the frames.

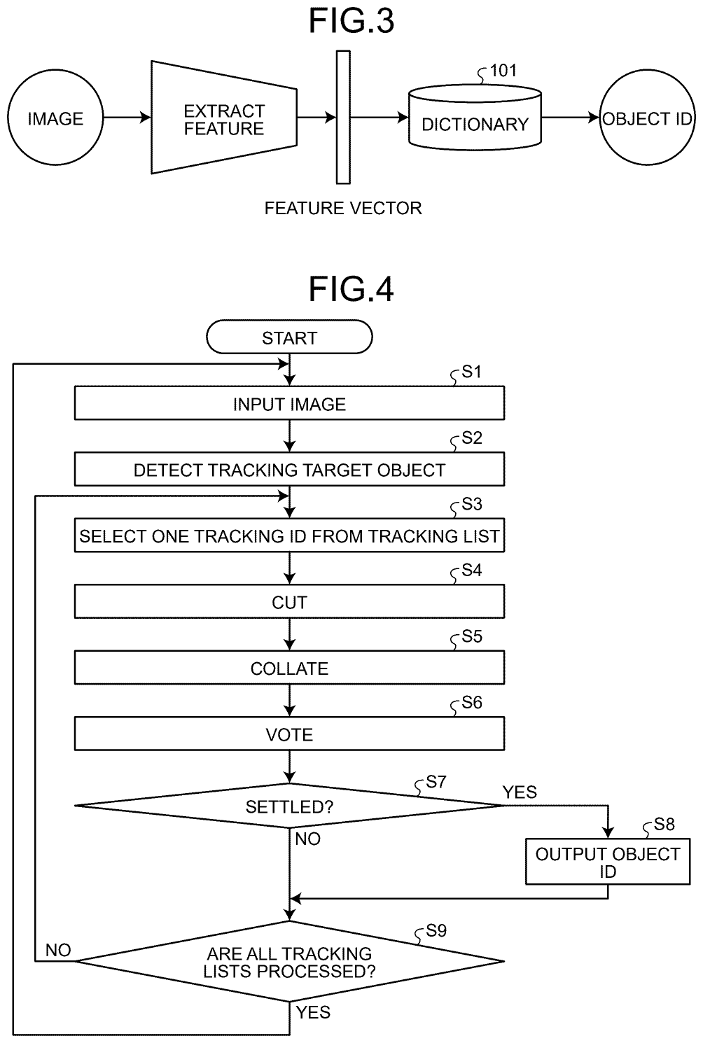

FIG. 3 is a diagram illustrating an example of a collation process of an object according to the first embodiment. The collation unit 13 extracts a feature vector for collation from an image region cut by the cutting unit 12 (feature extraction). The feature vector is, for example, a 512-dimensional vector.

As a feature extractor that performs feature extraction, for example, a neural network such as a convolutional neural network or a transformer is used. Such a feature extractor learns using a method called metric learning. The metric learning is a method of learning a measure representing a relationship between data (for example, distance and similarity), and can be used in image classification, image search, or the like. In the metric learning, a measure is learned such that feature amounts of data having similar meanings are close to each other and feature amounts of data having different meanings are distant from each other. As the metric learning, a method such as Contrastive loss (Hadsell, Raia, Sumit Chopra, and Yann LeCun. “Dimensionality reduction by learning an invariant mapping.” 2006 IEEE computer society conference on computer vision and pattern recognition (CVPR′06.) Vol. 2. IEEE, 2006), Triplet loss (Schroff, Florian, Dmitry Kalenichenko, and James Philbin. “Facenet: A unified embedding for face recognition and clustering.” Proceedings of the IEEE conference on computer vision and pattern recognition. 2015), CosFace (Wang, Hao, et al. “Cosface: Large margin cosine loss for deep face recognition.” Proceedings of the IEEE conference on computer vision and pattern recognition. 2018), or ArcFace (Deng, Jiankang, et al. “Arcface: Additive angular margin loss for deep face recognition.” Proceedings of the IEEE/CVF conference on computer vision and pattern recognition. 2019) is used.

The collation unit 13 collates the object ID by comparing the feature vector obtained from the image region with the feature vector of the object ID registered in the dictionary 101. For collation, for example, a cosine similarity is used. When the input feature vector is represented by q and the feature vector stored in the dictionary is represented by d, the cosine similarity is defined by Expression (1) below.

$$cos ( q , d ) = \frac{q \cdot d}{‖ q ‖ ‖ d ‖} \qquad ( 1 )$$

Here, “·” represents an inner product of the vectors, and norms of the denominator on the right side represents L2 norms. The collation unit 13 calculates cosine similarities between all of the feature vectors in the dictionary 101, and sets an object ID associated with a feature vector having the highest similarity to the collated object ID. In the first embodiment, the cosine similarity obtained herein is treated as the estimated score.

### Example of Information Processing

FIG. 4 is a flowchart illustrating an example of an overall flow of the information processing according to the first embodiment. First, the detection unit 11 receives an input of an image corresponding to one frame from a video such as a video image acquired by a camera in advance (Step S1).

Next, the detection unit 11 detects a tracking target object from the image by extracting a region including the tracking target object from the image (Step S2). For object detection, for example, Faster-R-CNN (Girshick, Ross. “Fast r-cnn.” Proceedings of the IEEE international conference on computer vision. 2015) is used. The detection unit 11 allocates a tracking ID for identifying the tracking target object, and generates a tracking list including the tracking ID of the detected object.

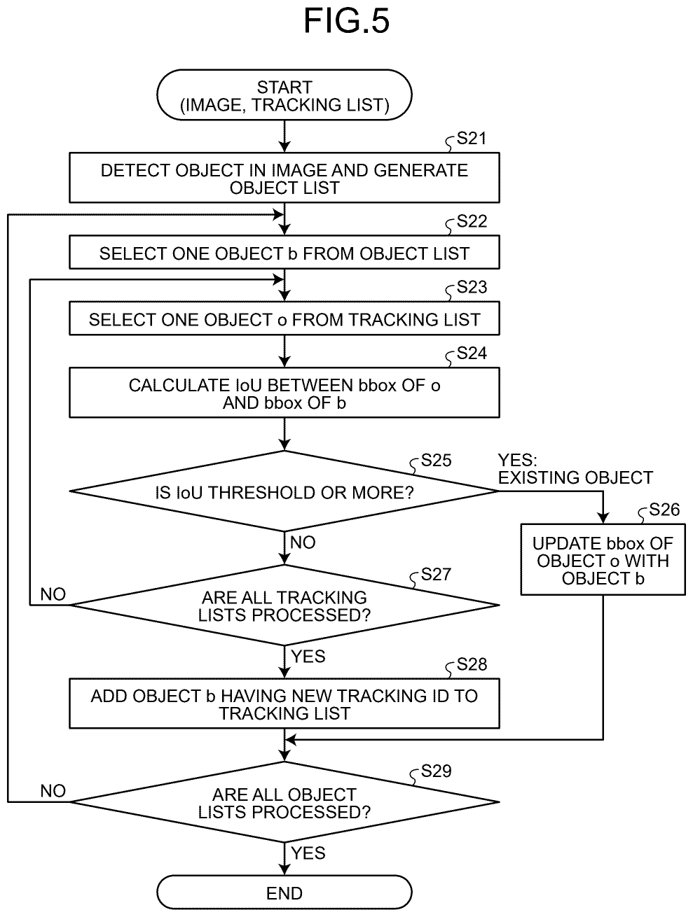

A detailed flow of Step S2 will be described below with reference to FIG. 5.

Next, the detection unit 11 selects one tracking ID for identifying a processing target object o from the tracking list (Step S3). The following processes are repeatedly performed for each of the tracking IDs in the tracking list.

Next, the cutting unit 12 cuts an image region including the object o selected in Step S3 from the image (Step S4). The image region may have any shape, and for example, when the image region has a rectangular shape, the image region is specified by box coordinates that specify the rectangular shape (coordinates that specify a position of a bounding box).

Next, the collation unit 13 obtains the object ID and the estimated score by collating the object o based on the dictionary 101 using the method described above in FIG. 3 (Step S5).

Next, the voting unit 14 votes for the object ID and the estimated score obtained in Step S5 (Step S6).

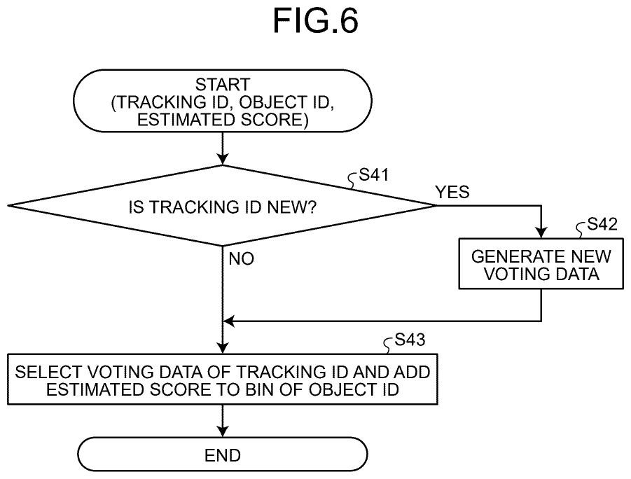

A detailed flow of Step S6 will be described below with reference to FIG. 6.

Next, the voting unit 14 performs the determination for the collation settlement (Step S7). When collation is settled (Step S7, Yes), the voting unit 14 outputs the object ID of which collation is settled (Step S8), and the process proceeds to Step S9. When collation is not settled (Step S7, No), the process proceeds to Step S9 without executing Step S8.

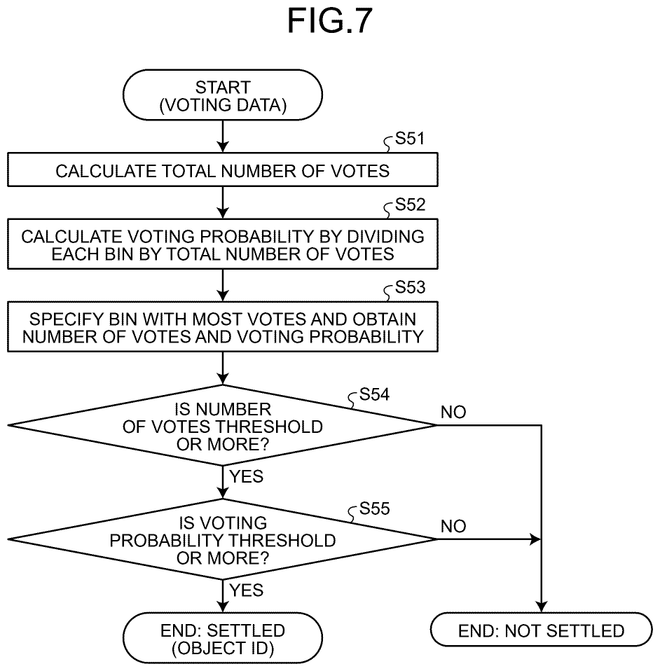

A detailed flow of Step S7 will be described below with reference to FIG. 7.

Next, the detection unit 11 determines whether all of the tracking IDs in the tracking list are processed (Step S9). When not all of the tracking IDs are processed (Step S9, No), the process returns to Step S3, and one non-processed tracking ID is selected from the tracking list. When all of the tracking IDs are processed (Step S9, Yes), the process returns to Step S1, and an input of an image corresponding to the next one frame is received.

Next, the detailed flow of Step S2 described above will be described with reference to FIG. 5.

FIG. 5 is a flowchart illustrating an example of a detection and tracking process of an object according to the first embodiment. When the process starts, the detection unit 11 selects an image in one frame of a processing target and a tracking list obtained in the processing performed until one frame before the selected image.

The tracking list is a list including tracking IDs and box coordinates (bbox: Bounding Box) of the tracking IDs, and indicates a position of an object that is being tracked. A format of the box coordinates is, for example, coordinates that specify the rectangular shape (an x coordinate on the upper left side, a y coordinate on the upper left side, an x coordinate on the lower right side, and a y coordinate on the lower right side).

As an initial value of the tracking list, an object detected in the first frame in a processing target video is set.

In the detection and tracking process of the object, as illustrated in FIG. 5, a region corresponding to the object is extracted and tracked. In typical object detection, there are labels of various objects such as people and vehicles, but in the first embodiment, all of the labels are treated as one object without being distinguished from each other (a presence or absence of an object is detected and tracked without detecting a type of the object).

First, the detection unit 11 detects an object in an image, and generates an object list including the detected object (Step S21). When the object is detected, the detection unit 11 (object detection engine) returns box coordinates representing a rectangular shape including the object. In object detection of Step S21, an object list that stores 0 or more detected box coordinates (bbox) is generated.

Next, the detection unit 11 selects one processing target object b from the object list generated in Step S21 (Step S22). Next, the detection unit 11 selects one processing target object o from the tracking list (Step S23).

For object tracking, using Intersection over Union (IoU), a method of tracking a front object having the largest overlapping area of bboxes is used. That is, a tracking method in which the object o and the object b are more likely to be determined to be the same object as the overlapping area of the bboxes increases is used.

Specifically, the detection unit 11 calculates the IoU (overlapping degree) between the bbox of the object o and the bbox of the object b (Step S24).

When the IoU is a threshold or more (Step S25, Yes), the detection unit 11 updates the bbox of the object o in the tracking list with the bbox of the object b (Step S26), and the process proceeds to Step S29.

Meanwhile, when the IoU is less than the threshold (Step S25, No), the detection unit 11 determines whether all of the objects o in the tracking list are processed (Step S27). When not all of the objects o are processed (Step S27, No), the process returns to Step S23, and one object o having a non-processed tracking ID is selected from the tracking list.

When all of the objects o are processed (Step S27, Yes), the detection unit 11 adds the object b having a new tracking ID to the tracking list as a new object (Step S28). Next, the detection unit 11 determines whether all of the objects b in the object list are processed (Step S29). When not all of the objects b are processed (Step S29, No), the process returns to Step S22, and one non-processed object b is selected from the object list.

When all of the objects b are processed (Step S29, Yes), the process in the image of the one frame ends.

Next, the detailed flow of Step S6 described above will be described with reference to FIG. 6.

FIG. 6 is a flowchart illustrating an example of a voting process according to the first embodiment. When the process starts, the voting unit 14 receives a tracking ID, an object ID, and an estimated score of the object ID.

First, the voting unit 14 determines whether the tracking ID is new (Step S41). When the tracking ID is new (Step S41, Yes), the voting unit 14 generates new voting data for the tracking ID (Step S42).

When the tracking ID is not new (Step S41, No), the voting unit 14 selects voting data for the tracking ID, and adds the estimated score to a bin of the object ID (Step S43). Specifically, the voting unit 14 adds the estimated score to the bin of the object ID (a voting destination label in the voting data) obtained in the collation process of Step S5 described above.

In the first embodiment, the estimated score is added, but any constant (for example, a predetermined value such as 1) may be added instead of the estimated score. When the constant is 1, the cumulative estimated score for each of the object IDs in the voting data represents the number of votes.

Next, the detailed flow of Step S7 will be described below with reference to FIG. 7.

FIG. 7 is a flowchart illustrating an example of a determination process according to the first embodiment. When the process starts, the voting unit 14 selects voting data of a determination target tracking ID.

First, the voting unit 14 calculates the total number of votes given to the object identified by the tracking ID (Step S51). Next, the voting unit 14 obtains (calculates) a voting probability of each of the object IDs by dividing each of the bins in the voting data (each of the object IDs) by the total number of votes (Step S52). Next, the voting unit 14 specifies the bin (object ID) with the most votes, and obtains the number of votes and the voting probability of the specified bin (Step S53).

Next, the voting unit 14 determines whether the number of votes obtained in Step S53 is a threshold or more (Step S54). When the number of votes is not the threshold or more (Step S54, No), the voting unit 14 ends the determination process as the collation of the object being not settled.

When the number of votes obtained in Step S53 is the threshold or more (Step S54, Yes), the voting unit 14 determines whether the voting probability obtained in Step S53 is a threshold or more (Step S55). When the voting probability is not the threshold or more (Step S55, No), the voting unit 14 ends the determination process as the collation of the object being not settled.

When the voting probability is the threshold or more (Step S55, Yes), the voting unit 14 settles collation of the object as the object ID of the bin with the most votes, and ends the determination process.

As in the flowchart of FIG. 7 described above, the determination process is a process of determining whether an answer to be settled. When a video (for example, a camera video) is an input and an answer representing which object is included in the video is decided, when a confidence score of a certain degree is obtained, the collation process in progress is interrupted and the answer is decided. In the example of FIG. 7, when the number of votes is the threshold or more and the voting probability is the threshold or more, it is determined that the confidence score of a certain degree is obtained.

As described above, in the information processing device 1 according to the first embodiment, the detection unit 11 detects a tracking target region including a tracking target from a frame in a video. The collation unit 13 collates the tracking target using a collation dictionary (in the first embodiment, the dictionary 101) that stores identification information (in the first embodiment, the object ID) for identifying a collation target and acquires identification information for identifying a collation result in the frame of the tracking target from the collation dictionary. The voting unit 14 obtains the voting data 102 by voting, for each of the tracking targets, the identification information for identifying the collation result obtained for each of the frames. Then, the determination unit 15 determines whether to settle collation based on the voting data 102 and outputs identification information for identifying the settled collation result (in the first embodiment, the object ID) when the collation is settled.

As a result, in the information processing device 1 according to the first embodiment, a processing time required for settling collation of a target (in the first embodiment, an object) can be shortened without a decrease in collation accuracy. Specifically, by introducing the voting mechanism, the information processing device 1 according to the first embodiment simultaneously achieves improvement of collation accuracy and a reduction in settlement time.

### Verification of Effect

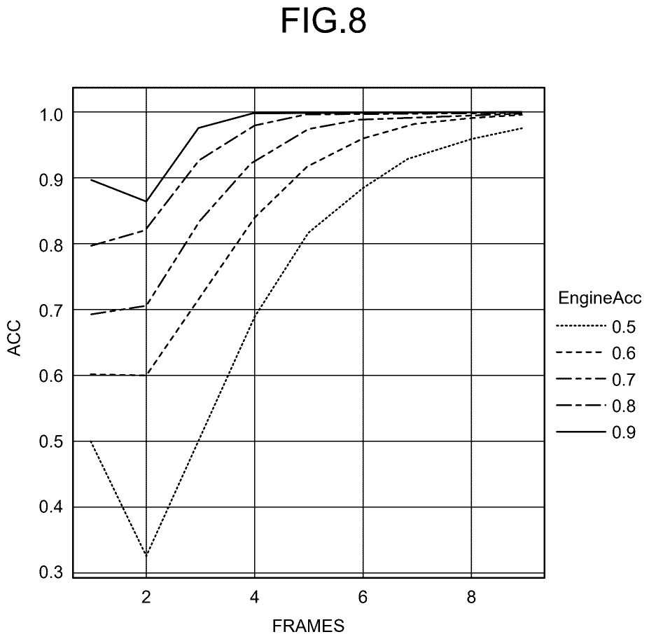

When one collation result is obtained for one frame, an answer based on the collation result was counted as one vote, a simple simulator was generated such that a result with the most votes is a final answer result, and an accuracy improvement effect of voting was verified by simple simulation (FIG. 8).

FIG. 8 is a diagram illustrating a relationship between the number of votes and the collation accuracy in the first embodiment. In the example of FIG. 8, a relationship between the number of frames and a final accuracy rate is plotted for each of engine accuracies (collation accuracy rates).

In the case of two-frame voting, because votes are split, decision power decreases and thus accuracy is considered to be decreased. However, for three or more frames, it can be seen that accuracy is significantly improved. Naturally, as accuracy of a single engine is higher, convergence of the final accuracy rate also becomes faster. As can be seen from FIG. 8, even when the accuracy rate for one frame is only 50%, by adopting six-frame voting, an accuracy rate of nearly 90% can be obtained.

When the accuracy rate for one frame is 50%, it is considered that an accuracy rate of 90% is hardly obtainable even if a best shot is selected; however, the accuracy rate can be reliably increased by voting. Accordingly, even in a situation where collation cannot be completed for a long time using a best shot, collation can be achieved by introducing the voting mechanism.

### First Modification Example of First Embodiment

Next, a first modification example of the first embodiment will be described. In the description of the first modification example, the same descriptions as those of the first embodiment will not be repeated, and different points from those of the first embodiment will be described. In the first modification example, a case where a tracking target is a face will be described.

### Example of Functional Configuration

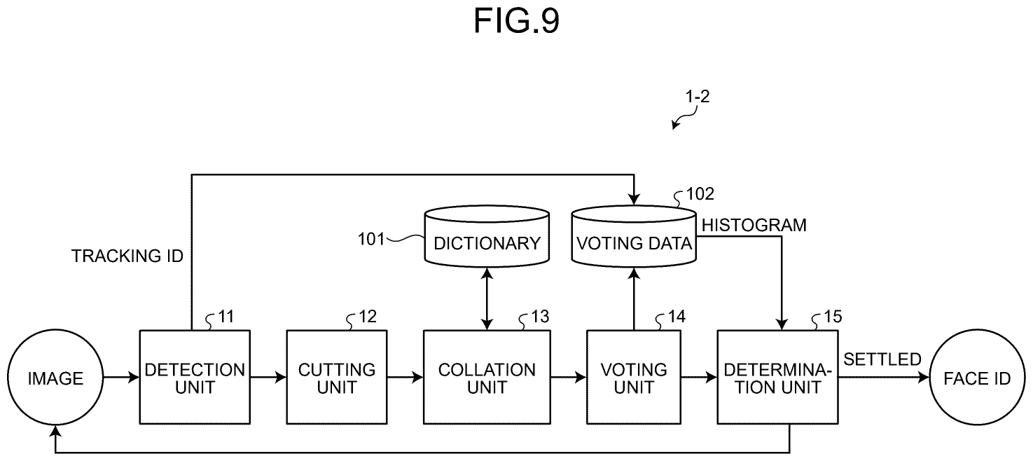

FIG. 9 is a diagram illustrating an example of a functional configuration of an information processing device 1-2 according to the first modification example of the first embodiment. The functional configuration according to the first modification example is the same as that of the first embodiment. In the first modification example, the detection unit 11 detects a tracking target region including a face from a frame in a video. The collation unit 13 collates a tracking target face using the dictionary 101 that stores identification information for identifying a collation target face (face ID) and acquires identification information for identifying a collation result in the frame from the dictionary 101. When collation is settled, the determination unit 15 outputs the settled face ID.

### Second Modification Example of First Embodiment

Next, a second modification example of the first embodiment will be described. In the description of the second modification example, the same descriptions as those of the first embodiment will not be repeated, and different points from those of the first embodiment will be described. In the second modification example, a case where a tracking target is a person will be described.

### Example of Functional Configuration

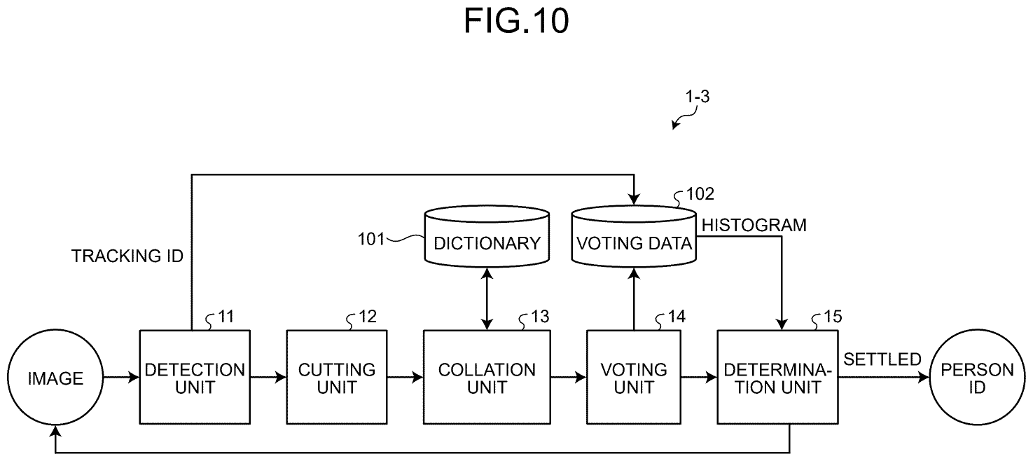

FIG. 10 is a diagram illustrating an example of a functional configuration of an information processing device 1-3 according to the second modification example of the first embodiment. The functional configuration according to the second modification example is the same as that of the first embodiment. In the second modification example, the detection unit 11 detects a tracking target region including a person from a frame in a video. The collation unit 13 collates a tracking target person using the dictionary 101 that stores identification information for identifying a collation target person (person ID) and acquires identification information for identifying a collation result in the frame from the dictionary 101. When collation is settled, the determination unit 15 outputs the settled person ID.

### Third Modification Example of First Embodiment

Next, a third modification example of the first embodiment will be described. In the description of the third modification example, the same descriptions as those of the first embodiment will not be repeated, and different points from those of the first embodiment will be described. In the third modification example, a case where the tracking target is a vehicle (for example, an automobile and the like) will be described.

### Example of Functional Configuration

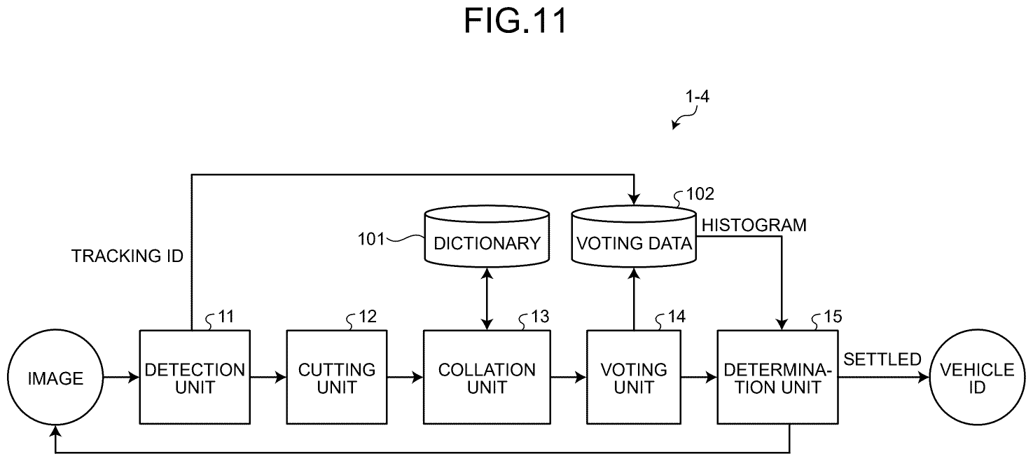

FIG. 11 is a diagram illustrating an example of a functional configuration of an information processing device 1-4 according to the third modification example of the first embodiment. The functional configuration according to the third modification example is the same as that of the first embodiment. In the third modification example, the detection unit 11 detects a tracking target region including a vehicle from a frame in a video. The collation unit 13 collates a tracking target vehicle using the dictionary 101 that stores identification information for identifying a collation target vehicle (vehicle ID) and acquires identification information for identifying a collation result in the frame from the dictionary 101. When collation is settled, the determination unit 15 outputs the settled vehicle ID.

### Second Embodiment

Next, a second embodiment will be described. In the description of the second embodiment, the same descriptions as those of the first embodiment will not be repeated, and different points from those of the first embodiment will be described. In the second embodiment, a case where a tracking target is a visual question answering (VQA) target in an image of each of frames will be described.

### Example of Functional Configuration

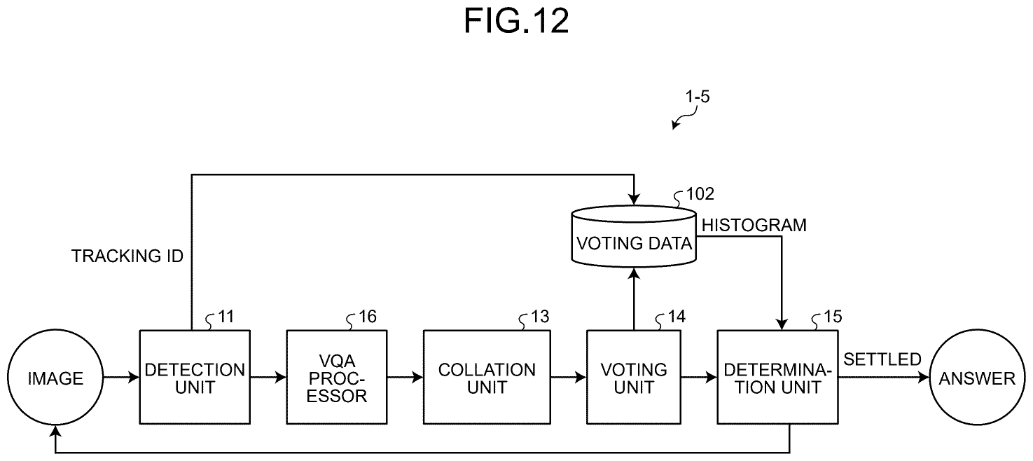

FIG. 12 is a diagram illustrating an example of a functional configuration of an information processing device 1-5 according to the second embodiment. The information processing device 1-5 according to the second embodiment includes the detection unit 11, the cutting unit 12, the voting unit 14, the determination unit 15, and a VQA processor 16. In addition, the information processing device 1-5 according to the second embodiment stores the voting data 102. In the second embodiment, the VQA processor 16 is provided instead of the collation unit 13 and the dictionary 101.

The VOA processor 16 performs a VQA process on a VQA target in the image region cut by the cutting unit 12. VQA is a process of determining a content from the image in response to any question and answering. A noticeable feature of the VOA is that a question is given using a free-form natural language text. As a result, theoretically, the VOA has high versatility in that any matter that can be expressed in text can be handled.

The voting unit 14 obtains voting data by voting, for each of the tracking targets, identification information for identifying an answer obtained for each of the frames.

The determination unit 15 determines whether to settle collation based on the voting data and outputs identification information for identifying the settled answer when collation is settled.

### Third Embodiment

Next, a third embodiment will be described. In the description of the third embodiment, the same descriptions as those of the first embodiment will not be repeated, and different points from those of the first embodiment will be described. In the third embodiment, a case where a function of giving feedback of a voting and settlement determination process to a user is further provided will be described.

### Example of Functional Configuration

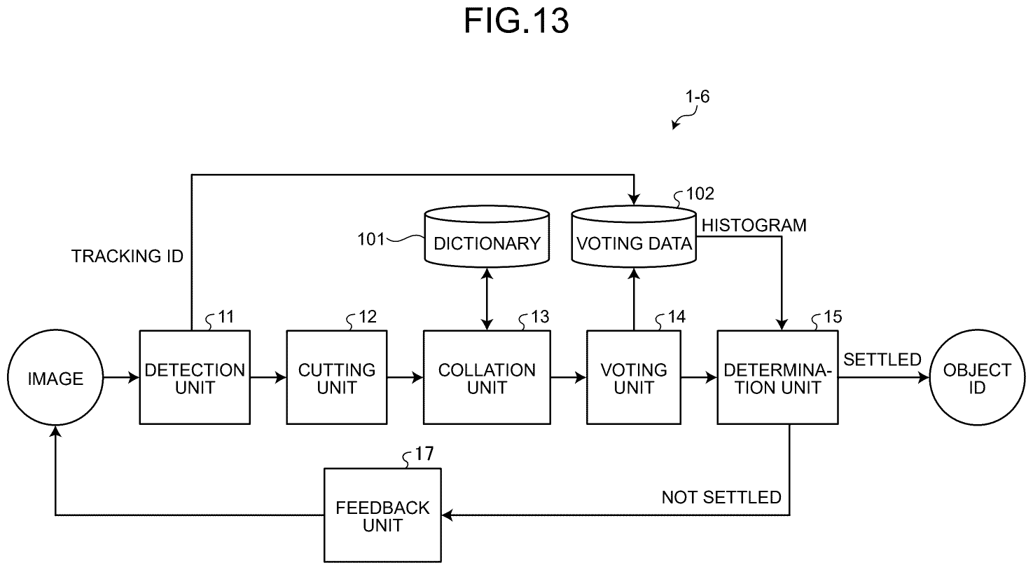

FIG. 13 is a diagram illustrating an example of a functional configuration of an information processing device 1-6 according to the third embodiment. The information processing device 1-6 according to the third embodiment includes the detection unit 11, the cutting unit 12, the collation unit 13, the voting unit 14, the determination unit 15, and a feedback unit 17. The information processing device 1-6 according to the third embodiment stores the dictionary 101 and the voting data 102. In the information processing device 1-6 according to the third embodiment, the feedback unit 17 is added.

The feedback unit 17 gives feedback of the voting and settlement determination process to the user, for example, by presenting display information for displaying feedback information to the user.

The feedback information includes, for example, a histogram representing the voting data (for example, the voting data illustrated in FIG. 1). In addition, for example, the feedback information includes the current number of votes and a progress bar representing the progress until collation settlement.

In the information processing device 1-6 according to the third embodiment, the user can perform, for example, adjustment of advancing a time until collation settlement by adjusting a threshold used in collation settlement based on the feedback information. As a result, it is possible to solve problems that occur when collation accuracy is excessively considered, such as a long time being required until collation settlement or collation being not settled.

Finally, an example of a hardware configuration of the information processing device 1 (1-2 to 1-6) according to the first to third embodiments will be described.

### Example of Hardware Configuration

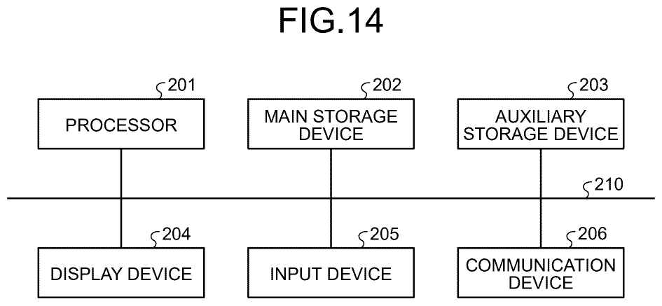

FIG. 14 is a diagram illustrating an example of the hardware configuration of the information processing device 1 (1-2 to 1-6) according to the first to third embodiments. The information processing device 1 includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected to each other via a bus 210.

The information processing device 1 may not include a part of the above-described configuration. For example, when the information processing device 1 can use an input function and a display function of an external device, the information processing device 1 does not need to include the display device 204 and the input device 205.

The processor 201 executes programs read from the auxiliary storage device 203 to the main storage device 202. The main storage device 202 is a memory such as a read only memory (ROM) or a random access memory (RAM). The auxiliary storage device 203 is a hard disk drive (HDD) or a memory card.

The display device 204 is, for example, a liquid crystal display. The input device 205 is an interface for operating the information processing device 1. The display device 204 and the input device 205 may also be implemented by, for example, a touch panel having a display function and an input function. The communication device 206 is an interface for communicating with other devices.

For example, the program executed by the information processing device 1 is provided as a computer program product stored in a computer-readable storage medium such as a memory card, a hard disk, a CD-RW, a CD-ROM, a CD-R, a DVD-RAM, or a DVD-R in an installable or executable file format.

In addition, for example, the program executed by the information processing device 1 may be configured to be provided by storing the program in a computer connected to a network such as the Internet and downloading the program via the network.

In addition, for example, the program executed by the information processing device 1 may be configured to be provided via a network such as the Internet without downloading the program. Specifically, for example, the program may be configured with, for example, an application service provider (ASP) type cloud service.

In addition, for example, the program of the information processing device 1 may be configured to be provided by incorporating the program into a ROM or the like in advance.

The program executed by the information processing device 1 may have a module configuration including functions that can be implemented by a program among the above-described functional configuration. Regarding each of the above-described functions, in actual hardware, each of the functional blocks is loaded to the main storage device 202 by allowing the processor 201 to read the program from the storage medium and to execute the read program. That is, each of the above-described functional blocks is generated in the main storage device 202.

Some or all of the above-described functions may be implemented by hardware such as an integrated circuit (IC) instead of being implemented by software.

In addition, each of the functions may be implemented using a plurality of processors 201, and then, each of the processors 201 may implement one function among the functions or may implement two or more functions among the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as:
a detection unit configured to detect a tracking target region including a tracking target from a frame in a video;
a collation unit configured to collate the tracking target using a collation dictionary that stores identification information for identifying a collation target and to acquire identification information for identifying a collation result in the frame of the tracking target from the collation dictionary;
a voting unit configured to obtain voting data by voting, for each of tracking targets, the identification information for identifying the collation result obtained for each of frames; and
a determination unit configured to determine whether to settle collation based on the voting data and to output identification information for identifying the settled collation result when the collation is settled.

2. The information processing device according to claim 1, wherein
the voting data is represented by a histogram of the identification information for identifying the collation result.

3. The information processing device according to claim 2, wherein
when the identification information for identifying the collation result obtained for each of the frames is voted for each of the tracking targets, the voting unit forms the histogram by adding an estimated score representing a certainty of the collation result.

4. The information processing device according to claim 2, wherein
when the identification information for identifying the collation result obtained for each of the frames is voted for each of the tracking targets, the voting unit forms the histogram by adding a predetermined value.

5. The information processing device according to claim 2, wherein
the determination unit determines whether to settle collation based on at least one of a frequency of the histogram for each of the identification information for identifying the collation result and a voting probability for each of the identification information for identifying the collation result.

6. The information processing device according to claim 5, wherein
the determination unit changes at least one of a threshold used for determining the frequency and a threshold used for determining the voting probability depending on a type of the collation target.

7. The information processing device according to claim 1, wherein
the detection unit generates a tracking list including the detected tracking target and updates the tracking list each time a new frame is input.

8. The information processing device according to claim 1, wherein
the collation dictionary stores a feature amount of the collation target in association with the identification information for identifying the collation target, and
the collation unit acquires the identification information for identifying the collation result in the frame of the tracking target from the collation dictionary by extracting a feature amount of the tracking target in the tracking target region and collating the collation target based on a similarity between a feature amount of the tracking target and a feature amount of the collation target.

9. The information processing device according to claim 1, wherein
the tracking target includes at least one of a face, a person, an object, and a visual question answering (VQA) target.

10. A computer program product having a non-transitory computer readable medium including programmed instructions stored thereon, wherein the instructions, when executed by a computer, cause the computer to function as:
a detection unit configured to detect a tracking target region including a tracking target from a frame in a video;
a collation unit configured to collate the tracking target using a collation dictionary that stores identification information for identifying a collation target and to acquire identification information for identifying a collation result in the frame of the tracking target from the collation dictionary;
a voting unit configured to obtain voting data by voting, for each of tracking targets, the identification information for identifying the collation result obtained for each of frames; and
a determination unit configured to determine whether to settle collation based on the voting data and to output identification information for identifying the settled collation result when the collation is settled.

11. An information processing method implemented by a computer of an information processing device, the method comprising:
detecting a tracking target region including a tracking target from a frame in a video;
collating the tracking target using a collation dictionary that stores identification information for identifying a collation target and acquiring identification information for identifying a collation result in the frame of the tracking target from the collation dictionary;
obtaining voting data by voting, for each of tracking targets, the identification information for identifying the collation result obtained for each of frames; and
determining whether to settle collation based on the voting data and outputting identification information for identifying the settled collation result when the collation is settled.
